(19) United States
(12) Patent Application Publication
(10) Pub. No.: US 2005/0080433 A1
(43) Pub. Date: Apr. 14, 2005

(54) Castration loop

(76) Inventor: Daniel L. Porter, Norton, KS (US)

Correspondence Address: James T. Robinson;Exclusivity-Law, Inc., 222 East Main Street, Norman, OK, 73060-1303, US

(21) Appl. No.: 10/681,715

(22) Filed: Oct. 8, 2003

(51) Int. Cl. A61D 1/06

(52) U.S. Cl. 606/135

(57) ABSTRACT

An improved castration loop for use in conjunction with a ligation tool is preformed from a section of surgical tubing to create a forward loop and a rearward loop. The preformed castration loop is created by crimping a deformable extruded aluminum clip to prevent the ends of the endless elastomeric loop from becoming separated. The forward loop is applied to an animal body part, and a second identical deformable extruded aluminum clip is crimped to adjacent sections of surgical tubing to prevent the elastomeric ligature material from slipping through the second extruded aluminum clip.

### BACKGROUND OF THE INVENTION

1. Field of the Invention

This invention relates generally to the field of livestock castration loops, and more particularly, but not by way of limitation, to an improved elastomeric endless ligation loop, also referred to herein as a castration loop, for use in a ligation tool.

2. Disscussion

Ligation is commonly used for removal of an animal body part. A band or cord is fastened to the body part, thereby cutting off the supply of blood from the body part to be removed. The body part atrophies and, in a few days or weeks, drops away from the body. Ligation has been found to be useful for castration.

U.S. Pat. No. 5,236,434 (Callicrate) discloses the use of an elastomeric ligature band to be used in conjunction with a ligation tool. Used in conjunction with the ligation tool, the ligature band is tightened quickly around the animal body part, thereby reducing the length of time the animal must be restrained.

U.S. Pat. No. 5,681,329 (Callicrate) discloses an endless band of elastomeric ligature material formed by securely connecting two ends of said ligature material by a wire. A deformable grommet is slidably attached to the endless band and crimped by a ligation tool. The grommet of the 5,681,329 patent is formed from a piece of flat wire wherein each end of the flat wire encircles one section of the ligature material. The ends of the flat wire grommet form a butt joint at a location generally between the two sections of ligature material.

The endless loop of the Callicrate '329 patent must be inserted into a ligation tool with the butt joint up. Failure to properly orient the Callicrate endless loop in the ligation tool results in failure of the ligation procedure on the animal body part. The rancher must then resort to surgical castration, which not only results in veterinarian charges but also results in slower weight gain, less efficient food-to-meat conversion, and decreased lean content in market livestock.

The improved castration loop of the present invention eliminates the flat wire and its problematic butt joint so that concerns regarding orientation in the ligation tool are eliminated.

### SUMMARY OF THE INVENTION

The present invention provides an improved castration loop preformed from a section of surgical tubing to create a forward loop and a rearward loop. The preformed castration loop is created by crimping an extruded aluminum clip to prevent the ends of the endless elastomeric loop from becoming separated. A second identical extruded aluminum clip prevents the elastomeric ligature material from slipping through the second extruded aluminum clip after the second extruded aluminum clip is crimped upon the endless loop.

An object of the present invention is to provide an improved castration loop which can be inserted in a ligation tool without regard to orientation of the device use to secure the castration loop on the animal body part.

Another object of the present invention is to provide a castration loop which uses two identical extruded aluminum clips (one to prevent the ends of the endless elastomeric loop from becoming separated and the other to secure the castration loop on the animal body part), thereby eliminating the need for two different parts (i.e., a wire to prevent the ends of the endless elastomeric from becoming separated and a flat wire grommet to secure the castration loop on the animal body part), thereby reducing the cost of manufacturing the castration loop.

Yet another object of the present invention is to reduce the likelihood of inadvertent misapplication of a castration loop in conjunction with a ligation tool.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is a view of the endless elastomeric ligature loop of the prior art.

FIG. 2 is another view of the endless elastomeric ligature loop of the prior art.

FIG. 3 is a view of the improved castration loop of the present invention.

FIG. 4 is another view of the improved castration loop of the present invention.

FIG. 5 shows the prior art elastomeric ligature loop as it is used in conjunction with a ligation tool.

FIG. 6 shows the improved castration loop of the present invention as it is used in conjunction with a ligation tool.

### DETAILED DESCRIPTION OF THE INVENTION

In the following description of the of the present invention, like numerals and characters designate like elements throughout the figures of the drawings.

Referring to FIGS. 1-2, a prior art elastomeric ligature loop 100 includes a forward loop 108 and a rearward loop 110 (requires the two pieces of elastomeric ligature material to be spread apart). A heavy gauged wire member 111 prevents the two ends of the endless elastomeric loop 100 from becoming separated. A grommet 32 is formed from rolled flat wire with a length and width sufficient to prevent the elastomeric ligature material from slipping through the grommet 32 after the grommet 32 is deformed upon the endless loop 100. The ends of the rolled flat wire form a butt joint 113.

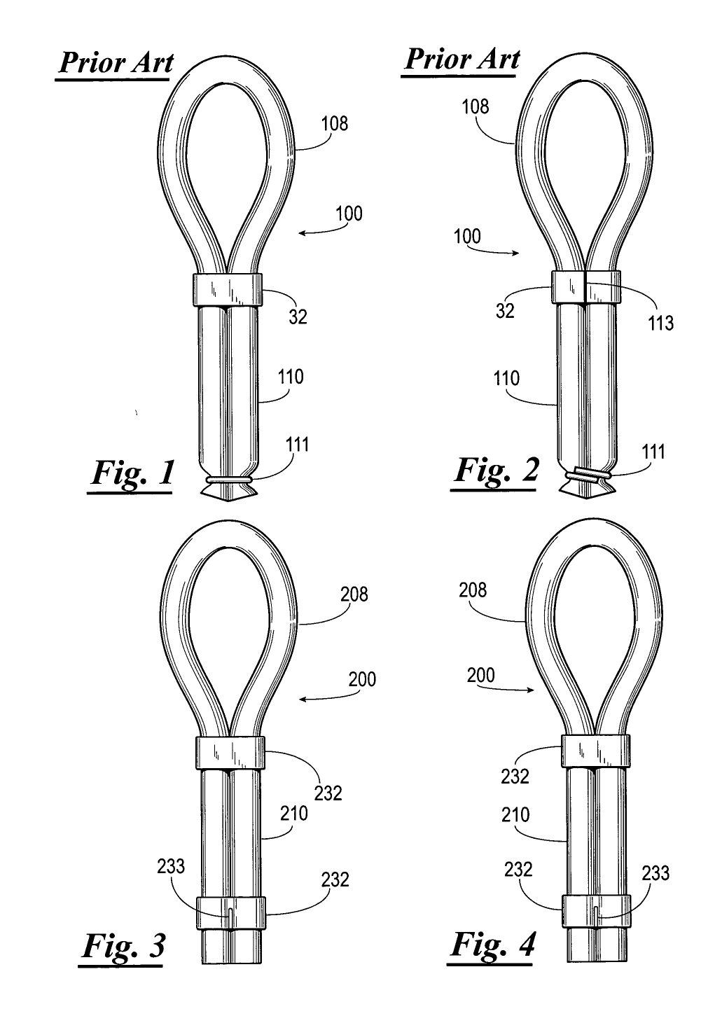

FIGS. 3 and 4 show the improved castration loop according to the present invention. A preformed endless elastomeric ligature loop 200 (a length of surgical rubber tubing folded so the ends are together) includes a forward loop 208 and a rearward loop 210 (requires the two pieces of surgical tubing are spread apart). An extruded aluminum clip 232 has been crimped (i.e., deformed) at 233 to prevent the ends of the endless elastomeric loop 200 from becoming separated. A second extruded aluminum clip 232 prevents the elastomeric ligature material from slipping through the second extruded aluminum clip 232 after the second extruded aluminum clip 232 is crimped (i.e., deformed) upon the endless loop 200.

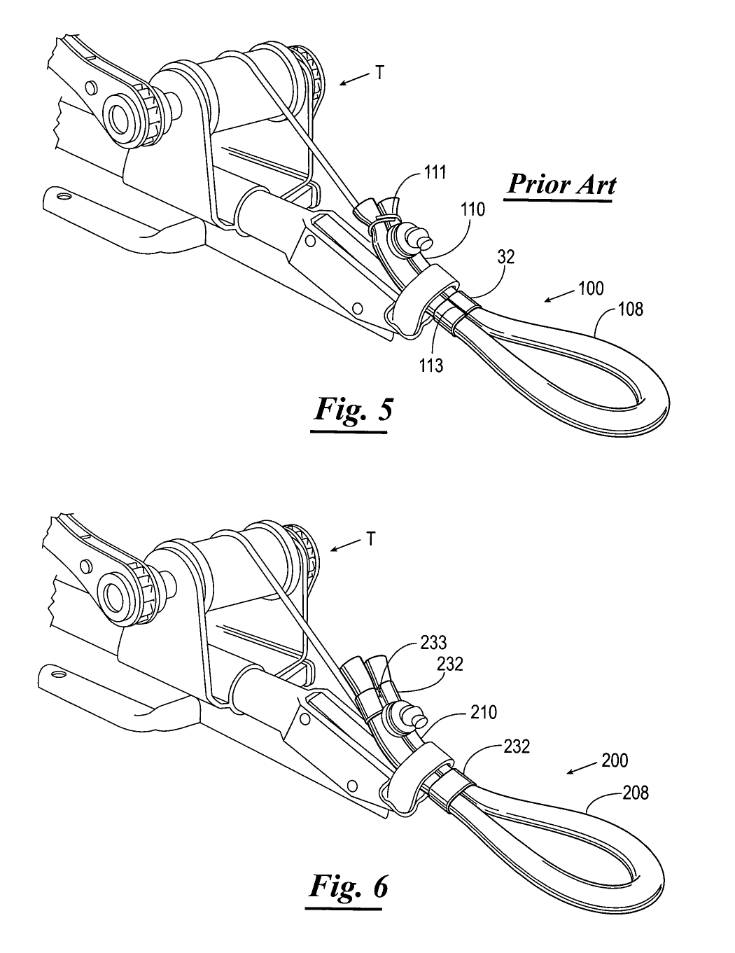

Referring now to FIG. 5, the elastomeric ligature loop 100 according to the prior art is shown as it is used in conjunction with a ligation tool T. Failure to orient the elastomeric ligature loop 100 with the butt joint 113 up results in results in failure of the ligation procedure on the animal body part. The rancher must then use surgical castration, which not only results in veterinarian charges but also results in slower weight gain, less efficient food-to-meat conversion, and decreased lean content in market livestock.

Referring now to FIG. 6, the improved castration loop 200 of the present invention is shown as it is used in conjunction with the ligation tool T. The use of the extruded aluminum clip 232 eliminates the possibility of improper orientation in the ligation tool T. Instead of the heavy gauge wire member 111 of the prior art elastomeric ligature loop 100, an identical extruded aluminum clip 232 to prevent the ends of the endless elastomeric loop 200 from becoming separated. This simplification results in improved manufacturing efficiency and reduced manufacturing costs.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A castration loop for use in conjunction with a ligation tool used to apply elastomeric ligature material to an animal body part, said castration loop comprising:
an endless ligation loop formed by securely connecting two ends of said
elastomeric ligature material by a first deformable extruded aluminum clip; and
a second deformable extruded aluminum clip slidably attached to said endless ligation loop.

2. The castration loop of claim 1, wherein deformation of said second deformable extruded aluminum clip forms a forward loop and a rearward loop in said endless ligation loop without significantly damaging said elastomeric ligature material.

3. The castration loop of claim 1, wherein said second deformable extruded aluminum clip is characterized as having a top and a bottom, and wherein said castration loop can be oriented in the ligation tool with said top facing upwardly away from the ligation tool.

4. The castration loop of claim 1, wherein said second deformable extruded aluminum clip is characterized as having a top and a bottom, and wherein said castration loop can be oriented in the ligation tool with said top facing downwardly toward the ligation tool.
